(19) United States
(12) Patent Application Publication
(10) Pub. No.: US 2013/0316165 A1
(43) Pub. Date: Nov. 28, 2013

(54) PRESSURE-SENSITIVE ADHESIVE SHEET

(71) Applicant: Nitto Denko Corporation, Osaka (JP)

(72) Inventors: Kenichi YAMAMOTO, Osaka (JP); Naoyuki NISHIYAMA, Osaka (JP)

(73) Assignee: NITTO DENKO CORPORATION, Osaka (JP)

(21) Appl. No.: 13/900,812

(22) Filed: May 23, 2013

(30) Foreign Application Priority Data
May 25, 2012 (JP) 2012-119838

(51) Int. Cl. C09J 7/02

(52) U.S. Cl. CPC C09J 7/0217
USPC 428/317.3; 428/336; 427/208.4; 156/60

(57) ABSTRACT

This invention provides a PSA sheet comprising a single PSA layer having a thickness of 100 μm or larger. The PSA layer is formed from a solvent-based PSA composition. When a cross-sectional area vertical to the PSA layer is observed, the PSA layer has fewer than 1.0 bubble of 100 μm size or larger per mm² of cross-sectional area. When the PSA layer is stored at 80° C. for 30 minutes, the mass of toluene released from the PSA layer is 10000 ppm or less of the mass of the PSA layer.

### CROSS-REFERENCE

The present application claims priority based on Japanese Patent Application No. 2012-119838 filed on May 25, 2012, and the entire contents thereof are incorporated herein by reference.

### BACKGROUND OF THE INVENTION

1. Field of the Invention

The present invention relates to a pressure-sensitive adhesive sheet formed with a solvent-based pressure-sensitive adhesive composition.

2. Description of the Related Art

In general, pressure-sensitive adhesive (PSA) exists as a soft solid (a viscoelastic body) in a room temperature range and has a property to adhere easily to an adherend with some pressure applied. Taking advantage of such properties, PSA has been widely used as an easy-to-handle, highly dependable means for attachment, for example, in a form of an adhesively double-faced PSA sheet (a double-faced PSA sheet) having a PSA layer on each of the first and the second faces of a non-releasable substrate (support).

PSA layers can be formed with various forms of PSA compositions such as a solvent-based PSA composition containing a PSA (an adhesive component) in an organic solvent, a water-dispersed PSA composition containing a PSA dispersed in an aqueous solvent, a ultraviolet (UV) ray-curable PSA composition prepared so as to form a PSA when cured with UV rays, a hot-melt PSA composition that can be applied in a heat-melted state, and the like. Among these, there still has been a strong demand for solvent-based PSA compositions for reasons such as that they are likely to produce high performance and/or highly advanced PSA sheets, etc. Technical literature related to PSA or PSA sheets include Japanese Patent Application Publication Nos. 2002-69394, 2004-202308, 2009-108132, and 2011-122013.

### SUMMARY OF THE INVENTION

Preferable constitutions (e.g., the thickness of PSA layers, types of substrates, etc.) of PSA sheets may vary depending on their intended purposes and forms of use. For example, with respect to double-faced PSA sheets having a PSA layer formed with a solvent-based PSA composition on each face of a non-woven fabric substrate, there is a desire for availability of a double-faced PSA sheet having a larger overall thickness (total thickness). In a double-faced PSA using a non-woven fabric substrate, a lower portion (the non-woven fabric side) of the PSA layer is integrated into the non-woven fabric. Thus, for example, given a double-faced PSA sheet having a 70 μm thick PSA layer on each of two faces of a 75 μm thick non-woven fabric, its overall thickness (total thickness) is close to the total thickness (i.e., 140 μm) of the two PSA layers combined, but not the total thickness (i.e., 215 μm) of the non-woven fabric and the two PSA layers provided on the respective faces combined. In a typical double-faced PSA sheet using a non-woven fabric substrate, the thickness of the PSA layer is about 60 μm to 80 μm per face, and thus, the total thickness of the double-faced PSA sheet turns out to be about 120 μm to 160 μm. In order to increase the total thickness of this type of double-faced PSA sheet, the PSA layers contained in the double-faced PSA sheet need to be increased. It is noted that a PSA layer formed with a solvent-based PSA composition may be referred to as a “solvent-based PSA layer” and a PSA constituting the PSA layer may be referred to as a “solvent-based PSA”.

When the solid content (non-volatile content, NV) of a PSA composition is constant, the thickness of a PSA layer formed by a single application will increase as the thickness of the application is increased. However, when a solvent-based PSA composition is applied thick, bubbles are likely to form during a process of drying the composition applied. Such bubbles (especially bubbles of 100 μm size or larger) may make the constitution of the PSA layer uneven (e.g., impairing the flatness and smoothness of the PSA layer surface), resulting in degraded performance of a PSA sheet comprising this PSA layer.

On the other hand, drying under milder conditions to suppress the formation of bubbles is likely to result in incomplete removal of the solvent from the solvent-based PSA composition with a larger amount of residual solvent remaining in the resulting PSA layer. In late years, along with a rise in the awareness of environmental sanitation, there is an increased desire for a reduction in the amount of VOC (volatile organic compounds) released from PSA sheets. Since a PSA sheet having a thick PSA layer contains a larger amount of PSA per area of the PSA sheet as compared to a PSA sheet having a thinner PSA layer, it is especially important to suppress its VOC content.

While Japanese Patent Application Publication Nos. 2002-69394, 2004-202308 and 2009-108132 look at prevention of bubble formation, the art according to each of these patent documents is intended for water-dispersed PSA compositions. PSA layers obtainable from water-dispersed PSA compositions obviously contain lower levels of VOC as compared to solvent-based PSA layers. Thus, when forming a PSA layer with a water-dispersed PSA composition, bubble formation can be prevented without special consideration to the level of residual solvent remaining in the PSA layer. As indicated in Japanese Patent Application Publication No. 2002-69394, drying behavior is quite different between water and organic solvents, techniques for drying water-dispersed PSA compositions to form PSA layers cannot be applied in the same manner to solvent-based PSA compositions.

With respect to a solvent-based PSA composition for optics, Japanese Patent Application Publication No. 2011-122013 offers a PSA composition less susceptible to bubble formation even when a thick PSA layer is formed via a single application, with the PSA layer being essentially free of residual solvent. However, the degree of prevention of bubble formation targeted by Japanese Patent Application Publication No. 2011-122013 is not so high as evident from that the presence of bubbles is visually observed in the worked examples (paragraph [0061]). In the worked examples of Japanese Patent Application Publication No. 2011-122013, odor of residual solvent is evaluated by smelling odor of a dry coating immediately after dried at 80° C. for 5 minutes (paragraph [0062]). However, such sensory evaluation is not so sensitive. Moreover, the strength of residual solvent odor immediately after dried and the amount of solvent released from the PSA layer while in use are two distinctive features. Thus, the amount of solvent (VOC) that may be released from a PSA while in use cannot be predicted simply by analogy to the results of evaluation of the strength of residual solvent odor immediately after dried.

For an intended purpose requiring a thicker double-faced PSA sheet, two double-faced PSA sheets may be adhered to each other and used, with each sheet having a typical thickness that includes a PSA layer of about 60 μm to 80 μm thickness on each face of a non-woven fabric substrate. However, with such double-layer use, adhering two double-faced PSA sheets to each other is a hassle. In addition, since an acrylic PSA exhibits poor autohesion (self-adhesion), when two double-faced acrylic PSA sheets are overlaid, the interfacial adhesion strength between the two double-faced PSA sheets tend to be insufficient. Also when several PSA layers are adhered (overlaid) to form a thicker PSA layer, the same problem occurs. Thus, a preferable PSA sheet comprises a single PSA layer (i.e., a PSA layer formed via a single application) having a large thickness.

The present invention has been made in view of such circumstances, and an objective thereof is to provide a PSA sheet comprising a single low-VOC solvent-based PSA layer having a large thickness and essentially free of bubbles that would alter its adhesive performance. A related other objective is to provide a method for producing a PSA sheet.

The PSA sheet provided by the present description comprises a single PSA layer having a thickness of 100 μm or larger. The PSA layer is formed from a solvent-based PSA composition. When a cross-sectional surface vertical to the PSA layer is observed, the PSA layer has fewer than 1.0 bubble of 100 μm size or larger per mm² of cross-sectional area. When the PSA layer is stored at 80° C. for 30 minutes, the mass of toluene released from the PSA layer is 10000 ppm or less of the mass of the PSA layer. As such, a PSA sheet comprising a PSA layer with an extremely low number of (i.e., with essentially no presence of) bubbles of 100 μM size or larger may be able to perform to its full potential as a solvent-based PSA because of the highly uniform (e.g., highly flat and smooth) PSA layer, etc. Since the residual solvent content remaining in the PSA layer is suppressed to a low level, the PSA sheet can better respond to desires for reduced VOC.

The present description also provides a method for producing a PSA sheet. The production method comprises a step (application step) of applying a solvent-based PSA composition to a substrate and a step (drying step) of allowing the PSA composition to dry on the substrate to obtain the PSA layer. In the application step, the solvent-based PSA composition can be applied to the substrate so as to form the PSA layer to have a thickness of 100 μm or larger after dried. The drying step comprises placing the PSA composition applied on the substrate in a drying oven and removing it from the drying oven. In the production method, when T_{Omax} is the maximum set temperature of the drying oven and T_{Amax} is the maximum temperature reached at the surface of the PSA composition in the drying oven, T_{Omax}-T_{Amax} is 20° C. or below. Such a production method can be preferably employed, for instance, as a method for producing a PSA sheet disclosed herein.

### BRIEF DESCRIPTION OF THE DRAWINGS

FIG. 1 shows a schematic cross-sectional view illustrating a constitution of a PSA sheet (substrate-backed doubled-faced PSA sheet) according to an embodiment.

FIG. 2 shows a schematic cross-sectional view illustrating a constitution of a PSA sheet (substrate-free double-faced PSA sheet) according to another embodiment.

FIG. 3 shows a schematic cross-sectional view illustrating a constitution of a PSA sheet (substrate-backed single-faced PSA sheet) according to another embodiment.

FIG. 4 shows a diagram schematically illustrating a PSA layer containing bubbles.

FIG. 5 shows a diagram illustrating a method for evaluating the peel property under a constant load.

FIG. 6(a)-(c) show scanning electron microscopy (SEM) images of cross-sections exposed by vertically cutting the double-faced PSA sheet according to Example 1.

FIG. 7(a)-(c) show SEM images of cross-sections exposed by vertically cutting the double-faced PSA sheet according to Example 2.

### DETAILED DESCRIPTION OF THE INVENTION

Preferred embodiments of the present invention are described below. Matters necessary to practice this invention other than those specifically referred to in this description may be understood as design matters based on the conventional art in the pertinent field for a person of ordinary skills in the art. The present invention can be practiced based on the contents disclosed in this description and common technical knowledge in the subject field. In the drawings referred to below, all members and sites providing the same effect are indicated by a common reference numeral, and redundant descriptions may be omitted or simplified.

In this description, as described earlier, “PSA” refers to a material that exists as a soft solid (a viscoelastic body) in a room temperature range and has a property to adhere easily to an adherend with some pressure applied. As defined in “Adhesion: Fundamental and Practice” by C. A. Dahlquist (McLaren & Sons (1966), P. 143), PSA referred to herein is a material that has a property satisfying complex tensile modulus E* (1 Hz)<10⁷ dyne/cm² (typically, a material that exhibits the said characteristics at 25° C.). The term “base polymer” of a PSA refers to the primary component among rubber-like polymers contained in the PSA. The primary component among rubber-like polymers refers to a component accounting for 50% by mass or greater (typically greater than 50% by mass) of the rubber-like polymers. Rubber-like polymer refers to a polymer that exhibits rubber elasticity in a room temperature range.

In the present description, “acrylic PSA” refers to a PSA comprising an acrylic polymer as the base polymer. “Acrylic polymer” refers to a polymer comprising a monomer having at least one (meth)acryloyl group per molecule (or an “acrylic monomer” hereinafter) as the primary monomeric component (primary monomer; i.e., a monomer that accounts for 50% by mass or greater of all the monomers constituting the acrylic polymer). The term “(meth)acryloyl group” comprehensively refers to an acryloyl group and a methacryloyl group. Similarly, the term “(meth)acrylate” comprehensively refers to acrylate and methacrylate.

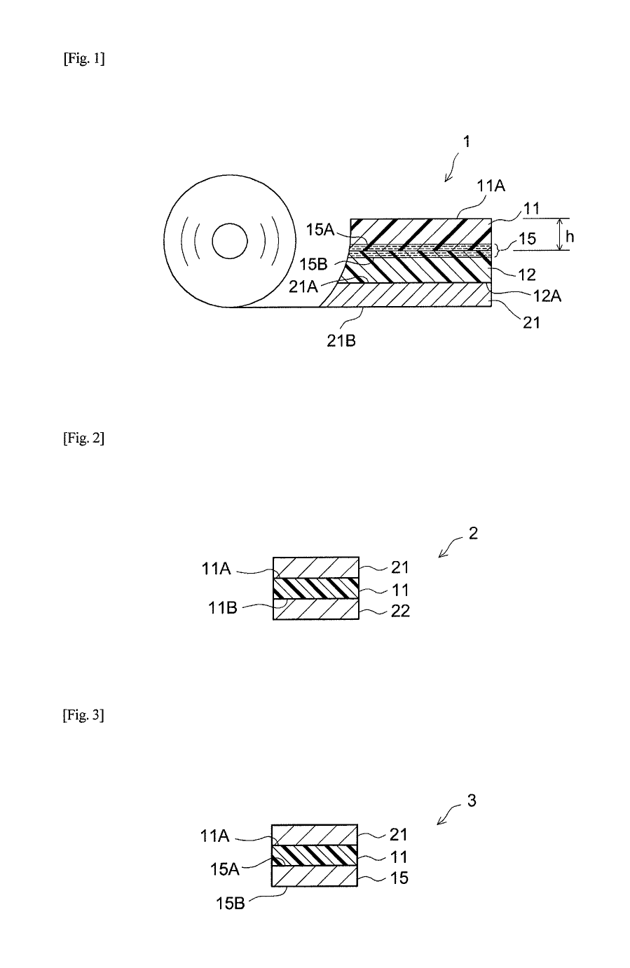

In the present description, when a PSA layer is partially integrated in a porous substrate (e.g., a non-woven fabric), the thickness of the PSA layer includes the thickness of the integrated portion. For example, in FIG. 1, with respect to a first PSA layer 11 provided on a first face 15A of non-woven fabric substrate 15, the thickness of the PSA layer 11 refers to the overall thickness h that includes the portion of the first PSA layer 11 integrated in non-woven fabric substrate 15 and the portion covering the first face 15A of non-woven fabric substrate 15. As schematically illustrated in FIG. 4, in the present description, the size of a bubble 30 contained in the PSA layer 11 refers to the maximum length (rim-to-rim length) L across the bubble 30. A typical bubble has a globular shape somewhat compressed in the thickness direction of the PSA layer. A bubble having such a shape is usually observed as an approximate oval bubble in a cross-section vertical to the PSA layer. The major diameter (the longest diameter) of the oval can be taken as the bubble size.

In the present description, the “set temperature” of an drying oven refers to the prescribed atmospheric temperature (surrounding temperature) to which the PSA composition applied on the substrate is exposed in the drying oven. The set temperature can be controlled to a desirable accuracy (e.g., within ±3° C., preferably within ±1° C.), for instance, by feedback control via reading the oven temperature from a thermometer, etc., placed at an appropriate position in the drying oven. When the drying oven is partitioned into some zones and constituted so that the PSA composition applied on the substrate is allowed to dry while passed sequentially through these zones, with the set temperature (the atmospheric temperature of the region where the PSA composition is passed through) of each zone being adjustable, “the maximum set temperature (T_{Omax})” is the highest set temperature among the zones. In an embodiment where the PSA composition is passed through a drying oven consisting of one zone, or in an embodiment where the PSA composition is placed to sit and allowed to dry in the drying oven, the set temperature and the maximum set temperature (T_{Omax}) of the said drying oven are the same.

In the present description, “the maximum temperature reached (T_{Amax})” at the PSA composition surface in a drying oven refers to the highest temperature reached at the surface of the PSA composition while the PSA composition (which can be seen as a PSA layer after dried) applied on the substrate is inside the drying oven (after it is placed in the oven through before it is removed from the oven). The maximum temperature reached (T_{Amax}) can be determined, for instance, by placing a temperature gauge sticker on the PSA composition applied on the substrate and allowing the PSA composition along with the temperature gauge sticker to dry in an drying oven. The temperature gauge sticker has regions (windows) that irreversibly change color when heated to certain temperatures. A typical temperature gauge sticker has several windows that indicate different color-transition temperatures. As the temperature gauge sticker, a commercial product can be suitably selected and used. It is usually preferable to use one having a measuring temperature range (interval) of about 10° C. or smaller (typically 5° C. to 7° C.).

### <PSA Layer>

The PSA sheet disclosed herein comprises a single solvent-based PSA layer having a thickness of 100 μm or larger (typically larger than 100 μm). Here, “a single PSA layer” refers to a PSA layer formed via a single application of the solvent-based PSA composition. Thus, the scope of the “single solvent-based PSA layer having a thickness of 100 μm or larger” referred to herein does not include a solvent-based PSA layer having a multi-layer constitution that includes some pre-formed solvent-based PSA layers with each having a thickness smaller than 100 μm (e.g., by adhering two solvent-based PSA layers with each having a thickness of about 70 μm) adhered to each other to an overall thickness of 100 μm or larger, or a solvent-based PSA layer having a multi-layer constitution that includes a solvent-based PSA layer of smaller than 100 μm thickness and another solvent-based PSA layer formed by applying and drying a solvent-based PSA composition thereon to have a thickness smaller than 100 μm after dried, with the overall thickness being 100 μm or larger. On the other hand, the scope of the “PSA sheet comprising a single solvent-based PSA layer having a thickness of 100 μm or larger” referred to herein may include a PSA sheet comprising a PSA layer having a multi-layer constitution with an overall thickness enlarged by adhering a PSA layer (which is usually preferable to be a solvent-based PSA layer, but not limited to this) having an arbitrary thickness to a single solvent-based PSA layer having a thickness of 100 μm or larger, and a PSA sheet comprising a PSA layer having a multi-layer constitution with an overall thickness enlarged by applying a PSA composition (which is usually preferable to be a solvent-based PSA composition, but not limited to this) to a single solvent-based PSA layer having a thickness of 100 μm or larger followed by drying or curing. The thickness of the PSA layer can be measured, for instance, according to the method for measuring the thickness of a PSA layer described later in the worked examples.

The art disclosed herein is applied to a PSA sheet comprising a single solvent-based PSA layer having a thickness of 100 μm or larger (typically larger than 100 μm, preferably 110 μm or larger, more preferably 120 μm or larger, even more preferably 130 μm or larger, e.g., 140 μm or larger). With respect to a PSA layer having such a large thickness, it has been difficult so far to reduce the number of bubbles in a single-layer constitution and reduce the amount of toluene released both to large extents at the same time; and therefore, it is especially meaningful to apply the art disclosed herein to make such a solvent-based PSA layer. The solvent-based PSA layer can have a thickness of, for example, 300 μm or smaller, and it is usually suitable to be 200 μm or smaller (preferably 180 μm or smaller, e.g., 160 μm or smaller). A single solvent-based PSA layer having such a thickness is preferable because the number of bubbles and the amount of toluene released can be reduced both to large extents at the same time while PSA sheets comprising the PSA layer can be efficiently produced. In a preferable embodiment of the art disclosed herein, the single solvent-based PSA layer has a thickness of 120 μm to 200 μm (typically 120 μm to 180 μm, e.g., 130 μm to 160 μm).

In addition to comprising a single solvent-based PSA layer having a large thickness as described above, the PSA sheet disclosed herein is characterized by the solvent-based PSA layer being essentially free of bubbles of 100 μm size or larger with the residual solvent content remaining in the solvent-based PSA layer being suppressed to a low level. Such a solvent-based PSA layer essentially free of bubbles of 100 μm size or larger may be able to perform to its full potential as a solvent-based PSA because of the highly uniform (e.g., highly flat and smooth) PSA layer, etc. For example, with respect to the adhesive properties such as the adhesive strength, peel property under a constant load, etc., as compared to a PSA sheet comprising a solvent-based PSA layer containing many bubbles of 100 μm size or larger, it may exhibit higher performance. Here, “being essentially free of bubbles of 100 μm size or larger” means that the number of bubbles of 100 μm size or larger observed in a cross-sectional surface vertical to the PSA layer is fewer than 1.0 per mm² of area of the cross-sectional surface. In the PSA sheet according to a preferable embodiment, the number of bubbles per mm² of cross-sectional area is fewer than 0.5 (more preferably fewer than 0.1, or may be zero). Such a PSA sheet may exhibit even greater adhesive performance. It is noted that the number of bubbles of 100 μm size or larger observed in the cross-sectional area is sometimes referred to as simply “the number of bubbles”. The number of bubbles can be determined, for instance, according to the method for evaluating the number of bubbles described later in the worked examples.

The PSA sheet according to a preferable embodiment, the number of bubbles of 90 μm size or larger observed in a cross-sectional area of the solvent-based PSA layer is fewer than 1.0/mm². It is more preferably fewer than 0.5/mm², even more preferably fewer than 0.1/mm², or it can be zero/mm² as well. The PSA sheet according to another preferable embodiment, the number of bubbles of 80 μm size or larger observed in a cross-sectional surface of the solvent-based PSA sheet is fewer than 1.0/mm². It is more preferably fewer than 0.5/mm², even more preferably fewer than 0.1/mm², or it can be zero/mm² as well. Such a PSA layer may have a highly flat and smooth surface. Thus, a PSA sheet comprising the said PSA layer may exhibit even greater adhesive performance.

It is preferable that the residual organic solvent content remaining in the solvent-based PSA layer is suppressed to a low level since it responds to recent desires for reduced VOC. The residual organic solvent content can be determined via a measurement of the amount of toluene released, with the measurement being carried out according to the following method:

### [Method for Measuring the Amount of Toluene Released]

A specimen containing a PSA layer of a prescribed size (e.g., 5 cm² in surface area) is placed in a vial and the vial is closed and sealed. The vial is heated at 80° C. for 30 minutes. Using a head space autosampler, a 1.0 mL sample of the air inside the vial is injected while hot into a gas chromatography system (GC analyzer) to measure the amount of toluene. The obtained data is converted to the mass of toluene to compute the toluene emission (the amount of toluene released) (ppm) per mass of the PSA layer contained in the sample.

For the mass of the PSA layer used in computing the amount of toluene released per mass of the PSA layer, can be used a value obtained by subtracting the mass of the substrate per the surface area of the sample from the mass of the PSA sheet excluding the mass of the release liner per surface area of the sample.

In a preferable embodiment of the PSA sheet disclosed herein, the amount of toluene released from the PSA layer when heated at 80° C. for 30 minutes (or abbreviated to simply “the amount of toluene released”, hereinafter) is preferably 10000 ppm or less of the mass of the PSA layer. The amount of toluene released is preferably 8000 ppm or less, or more preferably 7000 ppm or less. The lower limit of the amount of toluene released is not particularly limited. From the standpoint of the adhesive performance and production efficiency, etc., it is usually 100 ppm or greater of the mass of the PSA layer, and typically 500 ppm or greater (e.g., 1000 ppm or greater).

### <Examples of Constitutions of the PSA Sheet>

The PSA sheet (which may be a long strip such as tape, etc.) disclosed herein comprises at least one of the solvent-based PSA layer (typically, a single solvent-based PSA layer having a thickness of 100 μm or larger). Examples of a constitution of the PSA sheet comprising such a solvent-based PSA layer will be described referring to drawings.

Double-faced PSA sheet 1 shown in FIG. 1 comprises a first PSA layer 11 and a second PSA layer 12 on a first face 15A and a second face 15B of non-releasable substrate 15, respectively. Substrate 15 in this example is a non-woven fabric as a porous body, and lower portions (the inner portions in the cross-section) of PSA layers 11 and 12 are integrated in the non-woven fabric substrate 15, respectively. As shown in FIG. 1, prior to use (before adhered to an adherend), double-faced PSA 1 may be wound in a roll along with release liner 21 with both faces (front face 21A and back face 21B) being release faces. In double-faced PSA sheet 1 in such a form, the surface (the second adhesive face 12A) of the second PSA layer 12 and the surface (the first adhesive face 11A) of the first PSA layer 11 are protected with front face 21A and back face 21B of release liner 21, respectively. Alternatively, it may have a form in which the first adhesive surface 11A and the second adhesive face 12A are protected individually with two separate release liners. The art disclosed herein can be practiced in an embodiment where only one of PSA layers 11 and 12 in such a substrate-backed doubled-faced PSA sheet 1 is the solvent-based PSA layer (typically a single solvent-based PSA layer having a thickness of 100 μm or larger). It can be practiced also in an embodiment where each of PSA layers 11 and 12 is the solvent-based PSA layer. In the embodiment where only one of PSA layers 11 and 12 is the solvent-based PSA layer, the other PSA layer may be a single solvent-based PSA layer having a thickness smaller than 100 μm, or may be a PSA layer other than a solvent-based PSA layer. Examples of the PSA layer other than the solvent-based PSA layer include aqueous dispersion-based PSA layer, a UV-cured PSA layer, and so on. A substrate-backed double-faced PSA sheet in which each of PSA layers 11 and 12 is the solvent-based PSA layer contains more PSA per surface area of the PSA sheet. Thus, it is especially meaningful to apply the art disclosed herein and make a bubble-free PSA layer with low VOC.

The art disclosed herein can be applied not only to a substrate-backed double-faced PSA sheet as shown in FIG. 1, but also to a double-faced PSA sheet 2 free of a substrate (i.e., not having any substrate) as shown in FIG. 2. As shown in FIG. 2, double-faced PSA sheet 2 prior to use may be in a form where the first adhesive face 11A and the second adhesive face 11B of substrate-free PSA layer 11 are protected with release liners 21 and 22, respectively, with at least the PSA layer-side surface (front face) of each liner being a release face. Alternatively, with release liner 22 being omitted, it may be in a form where PSA layer 11 is overlaid on the front face of a release liner having a release face on each side and wound in a roll so that the back face of the release liner contacts and protects the second adhesive face 11B. The art disclosed herein can be practiced preferably in an embodiment where PSA layer 11 in such a substrate-free double-faced PSA sheet is the solvent-based PSA layer.

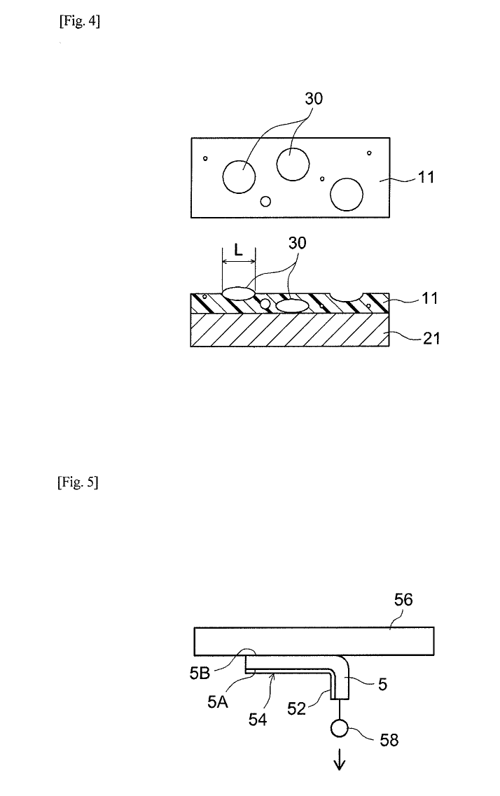

As shown in FIG. 3, the art disclosed herein can be applied also to an adhesively single-faced substrate-backed PSA sheet 3 comprising a substrate 15 and a PSA layer 11 supported by the first face (non-releasable face) 15A of the substrate. For example, as shown in FIG. 3, single-faced PSA sheet 3 prior to use may have a form where the surface (adhesive face) 11A of the PSA layer 11 is protected with release liner 21, with at least the PSA layer-side surface (front face) of the liner being a release face. Alternatively, with release liner 21 being omitted, it may have a form where substrate-backed PSA sheet 3 is wound in a roll along with substrate 15 with the second face 15B being a release face so that the second face 15B of substrate 15 contacts and protects the first adhesive face 11A. The art disclosed herein can be practiced preferably in an embodiment where PSA layer 11 in such a substrate-backed single-faced PSA sheet 3 is the solvent-based PSA layer.

Further description follows below referring to a case where the art disclosed herein is applied to a substrate-backed double-faced PSA sheet as a main example although the application of the said art is not to be limited to the example.

The type of PSA constituting the solvent-based PSA layer is not particularly limited. For example, the PSA layer may comprise one, two or more species selected from various known PSAs such as acrylic PSAs, polyester-based PSAs, urethane-based PSAs, polyether-based PSAs, rubber-based PSAs, silicone-based PSAs, polyamide-based PSAs, fluorine-based PSAs and the like.

### <Acrylic PSA>

In a preferable embodiment, the PSA constituting the solvent-based PSA layer comprises an acrylic PSA. For example, in a preferable PSA sheet, the solvent-based PSA layer is constituted with an acrylic PSA. With a PSA sheet comprising a solvent-based PSA layer constituted from an acrylic PSA as the main example, the art disclosed herein is described more in detail below although the solvent-based PSA layer is not to be limited to a layer formed of an acrylic PSA.

The acrylic polymer as the base polymer of the acrylic PSA typically comprises an alkyl (meth)acrylate as the primary monomer. As the alkyl (meth)acrylate, can be preferably used, for instance, a compound represented by the following formula (1):

CH₂═C(R¹)COOR² (1)

Here, in the formula (1), R¹ is a hydrogen atom or a methyl group. R² is an alkyl group (which means to include both acyclic alkyl groups and alicyclic alkyl groups) having 1 to 20 carbon atoms. Because of the likelihood that a PSA exhibiting great adhesive performance can be obtained, it is preferable that the alkyl (meth)acrylate has an acyclic alkyl group (which means to include both straight chain alkyl groups and branched alkyl groups) having 2 to 14 carbon atoms (such a range of the number of carbon atoms may be represented by C₂₋₁₄ hereinafter). Specific examples of a C₂₋₁₄ acyclic alkyl group include ethyl group, propyl group, isopropyl group, n-butyl group, isobutyl group, s-butyl group, t-butyl group, n-pentyl group, isoamyl group, neopentyl group, n-hexyl group, n-heptyl group, n-octyl group, isooctyl group, 2-ethylhexyl group, n-nonyl group, isononyl group, n-decyl group, isodecyl group, n-undecyl group, n-dodecyl group, n-tridecyl group, n-tetradecyl group, and the like. Examples of an alicyclic alkyl group that can be selected for R² include cyclohexyl group, isobornyl group, and the like.

In a preferable embodiment, of the total amount of monomers used for synthesis of the acrylic polymer, 50% by mass or greater (typically 50 to 99.9% by mass), or more preferably 70% by mass or greater (typically 70 to 99.9% by mass), for instance, 85% by mass or greater (typically 85 to 99.9% by mass) corresponds to one, two or more species selected from acyclic alkyl (meth)acrylates with R² in the formula (1) being a C₂₋₁₄ alkyl group (more preferably C₄₋₁₀ acyclic alkyl acrylates, e.g., one or each of n-butyl acrylate and 2-ethylhexyl acrylate). An acrylic polymer obtained from such a monomer composition is preferable because it is likely to form a PSA exhibiting good adhesive performance.

As the acrylic polymer in the art disclosed herein, can be preferably used one obtained by copolymerizing an acrylic monomer having a hydroxyl group (—OH). Specific examples of acrylic monomers having a hydroxyl group include 2-hydroxyethyl (meth)acrylate, 2-hydroxypropyl (meth)acrylate, 3-hydroxypropyl (meth)acrylate, 2-hydroxybutyl (meth)acrylate, 4-hydroxybutyl (meth)acrylate, 2-hydroxyhexyl (meth)acrylate, 6-hydroxyhexyl (meth)acrylate, 8-hydroxyoctyl (meth)acrylate, 10-hydroxydecyl (meth)acrylate, 12-hydroxylauryl (meth)acrylate, (4-hydroxymethylcyclohexyl)methyl acrylate, polypropylene glycol mono(meth)acrylate, N-hydroxyethyl(meth)acrylamide, N-hydroxypropyl(meth)acrylamide, and the like. Among these hydroxyl group-containing acrylic monomers, can be used one species solely, or two or more species in combination. Particularly preferable examples of a hydroxyl group-containing acrylic monomer include (meth)acrylates containing a hydroxyl group such as 2-hydroxyethyl (meth)acrylate, 2-hydroxypropyl (meth)acrylate, 3-hydroxypropyl (meth)acrylate, 2-hydroxybutyl (meth)acrylate and 4-hydroxybutyl (meth)acrylate. Such a hydroxyl group-containing acrylic monomer can be used in an amount ranging from about 0.01 to 20% by mass of the total amount of monomers used for synthesis of an acrylic polymer, and it is usually preferable to be used in an amount ranging from about 0.05 to 15% by mass, or more preferably in an amount ranging from about 0.1 to 10% by mass.

The copolymer composition of the acrylic polymer is suitably designed so that the polymer exhibits a glass transition temperature (Tg) of −15° C. or below (e.g., −70° C. to −15° C.), preferably −25° C. or below (e.g., −70° C. to −25° C.), or more preferably −40° C. or below (e.g., −70° C. to −40° C.). An acrylic polymer exhibiting such a glass transition temperature is preferable because it is likely to form a PSA that exhibits good adhesive performance.

Herein, the Tg of an acrylic polymer refers to a value determined from the Fox equation based on the Tg values of the homopolymers of the respective monomers constituting the polymer and the mass fractions (copolymerization ratio based on the mass) of these monomers. Thus, the Tg value of an acrylic polymer can be adjusted by suitably modifying the monomer composition (types and proportions of monomers used for synthesis of the polymer). As the Tg values of homopolymers, values given in a known document are used.

In the art disclosed herein, as the Tg values of the homopolymers, the following values are used specifically:

| | |
|---|---|
| 2-ethylhexyl acrylate | −70° C. |
| n-butyl acrylate | −55° C. |
| ethyl acrylate | −22° C. |
| methyl acrylate | 8° C. |
| methyl methacrylate | 105° C. |
| cyclohexyl methacrylate | 66° C. |
| vinyl acetate | 32° C. |
| styrene | 100° C. |
| acrylic acid | 106° C. |
| methacrylic acid | 130° C. |

With respect to the Tg values of homopolymers other than the examples listed above, the values given in “Polymer Handbook” (3rd edition, John Wiley & Sons, Inc., Year 1989) are used.

When no values are given in the “Polymer Handbook” (3rd edition, John Wiley & Sons, Inc., Year 1989), values obtained by the following measurement method are used (see Japanese Patent Application Publication No. 2007-51271).

In particular, to a reaction vessel equipped with a thermometer, a stirrer, a nitrogen inlet and a condenser, are added 100 parts by mass of monomer, 0.2 part by mass of azobisisobutyronitrile, and 200 parts by mass of ethyl acetate as a polymerization solvent, and the mixture is stirred for one hour under a nitrogen gas flow. After oxygen is removed in this way from the polymerization system, the mixture is heated to 63° C. and the reaction is carried out for 10 hours. Then, it is cooled to room temperature, and a homopolymer solution having 33% by mass solids content is obtained. Then, this homopolymer solution is applied onto a release liner by flow coating and allowed to dry to prepare a test sample (a sheet of homopolymer) of about 2 mm thickness. This test sample is cut out into a disc of 7.9 mm diameter and is placed between parallel plates; and while applying a shear strain at a frequency of 1 Hz using a rheometer (ARES, available from Rheometrics Scientific, Inc.), the viscoelasticity is measured in the shear mode over a temperature range of −70° C. to 150° C. at a heating rate of 5° C./min; and the temperature value at the maximum of the tan δ curve is taken as the Tg of the homopolymer.

Other monomers besides those described above may also be copolymerized in the acrylic polymer in the art disclosed herein within a range that does not remarkably impair the effects of the present invention. Such other monomers can be used for the purpose of, for example, adjusting the Tg of the acrylic polymer or adjusting the adhesive properties. Examples of monomers capable of increasing the cohesive strength and the heat resistance of a PSA include sulfonic acid group-containing monomers, phosphoric acid group-containing monomers, cyano group-containing monomers, vinyl esters, aromatic vinyl compounds, and so on. In addition, examples of monomers that can introduce a functional group into the acrylic polymer that can become a crosslinking site or contribute to an increase in the adhesive strength include carboxyl group-containing monomers, acid anhydride group-containing monomers, amide group-containing monomers, amino group-containing monomers, imide group-containing monomers, epoxy group-containing monomers, (meth)acryloylmorpholine, vinyl ethers, and so on.

Examples of sulfonic acid group-containing monomers include styrene sulfonic acid, allyl sulfonic acid, 2-(meth)acrylamido-2-methylpropanesulfonic acid, (meth)acrylamidopropanesulfonic acid, sulfopropyl (meth)acrylate, (meth)acryloxynaphthalene sulfonic acid, sodium vinylsulfonate and the like.

Examples of phosphoric acid group-containing monomers include 2-hydroxyethyl acryloyl phosphate.

Examples of cyano group-containing monomers include acrylonitrile, methacrylonitrile and the like.

Examples of vinyl esters include vinyl acetate, vinyl propionate, vinyl laurate, and the like. Examples of aromatic vinyl compounds include styrene, chlorostyrene, chloromethylstyrene, α-methylstyrene, other substituted styrenes, and the like.

Examples of carboxyl group-containing monomers include acrylic acid, methacrylic acid, carboxyethyl (meth)acrylate, carboxypentyl (meth)acrylate, itaconic acid, maleic acid, fumaric acid, crotonic acid, isocrotonic acid, and the like.

Examples of acid anhydride group-containing monomers include maleic anhydride, itaconic anhydride, acid anhydrides of the carboxyl group-containing monomers, and the like.

Examples of amide group-containing monomers include acrylamide, methacrylamide, diethylacrylamide, N-vinylpyrrolidone, N,N-dimethylacrylamide, N,N-dimethylmethacrylamide, N,N-diethylacrylamide, N,N-diethylmethacrylamide, N,N′-methylenebisacrylamide, N,N-dimethylaminopropylacrylamide, N,N-dimethylaminopropyl methacrylamide, diacetone acrylamide, and the like.

Examples of amino group-containing monomers include aminoethyl (meth)acrylate, N,N-dimethylaminoethyl (meth)acrylate and N,N-dimethylaminopropyl (meth)acrylate.

Examples of imide group-containing monomers include cyclohexylmaleimide, isopropylmaleimide, N-cyclohexylmaleimide, itaconimide, and the like.

Examples of epoxy group-containing monomers include glycidyl (meth)acrylate, methylglycidyl (meth)acrylate, allyl glycidyl ether, and the like.

Examples of vinyl ethers include methyl vinyl ether, ethyl vinyl ether, isobutyl vinyl ether, and the like.

While among these “other monomers”, one species can be used solely, or two or more species can be used in combination, their total content in the monomers used to synthesize the acrylic polymer is preferably about 40% by mass or less (typically, 0.001 to 40% by mass), and more preferably about 30% by mass or less (typically, 0.001 to 30% by mass). Also, the acrylic polymer may have a composition free of the other monomers (such as that obtained by using only a C₂₋₁₄ alkyl (meth)acrylate as the monomer, or that obtained by using only a C₂₋₁₄ alkyl (meth)acrylate and a hydroxyl group-containing (meth)acrylate).

The acrylic polymer in the art disclosed herein preferably has a weight average molecular weight (Mw) in a range of, for instance, 20×10⁴ or greater, but 90×10⁴ or less (more preferably 30×10⁴ or greater, but 80×10⁴ or less) when determined based on standard polystyrene by gel permeation chromatography (GPC). An acrylic polymer having such a molecular weight is preferable because it is likely to form a PSA that exhibits good adhesive performance.

The method for obtaining such an acrylic polymer having such a monomer composition is not particularly limited, and the polymer can be obtained by applying various polymerization methods generally used as methods for synthesizing acrylic polymers, such as solution polymerization methods, emulsion polymerization methods, bulk polymerization methods, suspension polymerization methods, and the like. In addition, the acrylic polymer may be a random copolymer, block copolymer, graft copolymer, or the like. From the standpoint of the productivity, etc., a random copolymer is usually preferable. In view of the ease of preparation of a solvent-based PSA composition containing the acrylic polymer, it is usually preferable to employ a solution polymerization method as the method for synthesizing the acrylic polymer. As the organic solvent (polymerization solvent) for solution polymerization, can be used a single species or a suitable combination of toluene, ethyl acetate, hexane, cyclohexane, and the like.

### <PSA Composition>

The solvent-based PSA composition in the art disclosed herein may be present as a composition containing an adhesive component in an organic solvent. As the organic solvent, can be used a single species or a suitable combination of toluene, xylene, ethyl acetate, hexane, cyclohexane, methylcyclohexane, isopropanol and the like. It can be a single solvent species consisting of one of toluene, xylene, ethyl acetate, hexane, cyclohexane, methylcyclohexane, and isopropanol, or a mixed solvent comprising one of these as the primary component (a component accounting for greater than 50% by mass of the organic solvent).

Such a solvent-based PSA composition preferably has an NV in a range of 30 to 60%, or more preferably 30 to 50% (e.g., 35 to 45%). A solvent-based PSA composition having such an NV is suitable for forming a single solvent-based PSA layer having a large thickness and being of high quality (i.e., having few bubbles and a suppressed amount of toluene released).

The solvent-based PSA composition has a viscosity in a range of preferably 3 Pa·s to 25 Pa·s, or more preferably 5 Pa·s to 15 Pa·s. A solvent-based PSA composition exhibiting such a viscosity coupled with application of the production method disclosed herein is suitable for forming a single high-quality solvent-based PSA layer having a large thickness. The viscosity refers to a viscosity measured at 23° C. with a rotational viscometer. More specifically, it can be measured by applying the viscosity measurement method described later in the worked examples.

### <Crosslinking Agent>

As such a solvent-based PSA composition, can be preferably utilized a PSA composition constituted so that the acrylic polymer contained in the composition can be suitably crosslinked. As a specific crosslinking means, can be preferably employed a method comprising: introducing crosslinking sites into the acrylic polymer by copolymerizing a monomer having a suitable functional group (a hydroxyl group, carboxyl group, etc.) and adding to the acrylic polymer a compound (crosslinking agent) capable of reacting with that functional group to form a crosslink. As the crosslinking agent, can be used various types of material used for crosslinking of general acrylic polymers, such as an isocyanate compound, an epoxy compound, a melamine-based compound, an aziridine compound, or the like. Among these crosslinking agents, one species may be used alone, or two or more types may be used in combination.

Examples of isocyanate compounds used as crosslinking agents include aromatic isocyanates such as tolylene diisocyanate, xylylene diisocyanate, etc.; alicyclic isocyanates such as isophorone diisocyanate, etc.; aliphatic isocyanates such as hexamethylene diisocyanate, etc.; and the like. More specific examples include lower aliphatic polyisocyanates such as butylene diisocyanate, hexamethylene diisocyanate, etc.; alicyclic isocyanates such as cyclopentylene diisocyanate, cyclohexylene diisocyanate, isophorone diisocyanate, etc.; aromatic diisocyanates such as 2,4-tolylene diisocyanate, 4,4′-diphenylmethane diisocyanate, xylylene diisocyanate, etc.; isocyanate adducts such as trimethylolpropane/tolylene diisocyanate trimer adduct (trade name “CORONATE L” available from Nippon Polyurethane Industry Co., Ltd.), trimethylolpropane/hexamethylene diisocayante trimer adduct (trade name “CORONATE HL” available from Nippon Polyurethane Industry Co., Ltd.), an isocyanurate of hexamethylene diisocyanate (trade name “CORONATE HX” available from Nippon Polyurethane Industry Co., Ltd.), etc.; and the like. Among these isocyanate compounds, one species may be used alone, or two or more types may be used in combination.

Examples of epoxy compounds used as crosslinking agents include N,N,N,N′-tetraglycidyl-m-xylene diamine (trade name “TETRAD-X” available from Mitsubishi Gas Chemical Inc.), 1,3-bis(N,N-diglycidylaminomethyl)cyclohexane (trade name “TETRAD-C” available from Mitsubishi Gas Chemical Inc.), and the like. Examples of melamine-based resins include hexamethylol melamine and the like. Examples of commercially available aziridine derivatives include products of under trade names “HDU”, “TAZM” and “TAZO” available from Sogo Pharmaceutical Co., Ltd.

The amount of crosslinking agent used is usually suitable to be about 0.01 to 15 parts by mass relative to 100 parts by mass of the acrylic polymer and it is preferable to be about 0.1 to 10 parts by mass (e.g., about 0.2 to 2 parts by mass). A solvent-based PSA composition containing a crosslinking agent in such an amount is preferable since it is likely to form a PSA that exhibits good adhesive performance.

The PSA composition may further contain various conventionally known additives as necessary. Examples of such additives include surface lubricants, leveling agents, antioxidants, preservatives, photostabilizing agents, ultraviolet(UV)-ray absorbing agents, polymerization inhibitors, silane coupling agents, and the like. Can be also added a tackifier resin known and/or commonly used in a PSA composition comprising an acrylic polymer as the base polymer.

### <Tackifier Resin>

As the tackifier resin, can be used various tackifier resins that are rosin-based, terpene-based, hydrocarbon-based, epoxy-based, polyamide-based, elastomer-based, phenol-based, ketone-based and so on, although not particularly limited to these. These tackifier resins can be used as a single species or in combination of two or more species.

Examples of the rosin-based resin include unmodified rosins (raw rosins) such as gum rosin, wood rosin, tall-oil rosin, etc.; modified rosins obtainable from these unmodified rosins via a modification such as hydrogenation, disproportionation, polymerization, etc. (hydrogenated rosins, disproportionated rosins, polymerized rosins, other chemically-modified rosins, etc.); various other rosin derivatives; and the like. Examples of the rosin derivatives include rosin esters such as unmodified rosins esterified with alcohols (i.e., esterification products of unmodified rosins) and modified rosins (hydrogenated rosins, disproportionated rosins, polymerized rosins, etc.) esterified with alcohols (i.e., esterification products of modified rosins), and the like; unsaturated fatty-acid-modified rosins obtainable from unmodified rosins or modified rosins (hydrogenated rosin, disproportionated rosin, polymerized rosin, etc.) via modifications with unsaturated fatty acids; unsaturated fatty-acid-modified rosin esters obtainable from rosin esters via modifications with unsaturated fatty acids; rosin alcohols obtainable via reduction of carboxyl groups from unmodified rosins, modified rosins (hydrogenated rosins, disproportionated rosins, polymerized rosin, etc.), unsaturated fatty-acid-modified rosins or unsaturated fatty-acid-modified rosin esters; metal salts of rosins (in particular, of rosin esters) including unmodified rosins, modified rosins, various rosin derivatives, etc.; rosin phenol resins obtainable from rosins (unmodified rosins, modified rosins, various rosin derivatives, etc.) via addition of phenol in the presence of an acid catalyst followed by thermal polymerization; and so on.

Examples of a terpene-based tackifier resins include terpene-based resins such as α-pinene polymers, β-pinene polymers, dipentene polymers, etc.; modified terpene-based resins from the modification (e.g., phenol modification, aromatic group modification, hydrogenation, hydrocarbon modification, and so on) of these terpene-based resins; and so on. Examples of the modified terpene-based resins include terpene-phenol-based resins, styrene-modified terpene-based resins, aromatic-group-modified terpene-based resins, hydrogenated terpene-based resins, and the like.

Examples of a hydrocarbon-based tackifier resin include various hydrocarbon-based resins such as aliphatic hydrocarbon resins, aromatic hydrocarbon resins, alicyclic hydrocarbon resins, aliphatic-aromatic petroleum resins (styrene-olefin-based copolymers, etc.), aliphatic-alicyclic petroleum resins, hydrogenated hydrocarbon resins, coumarone-based resins, coumarone-indene-based resins, and the like. Examples of an aliphatic hydrocarbon resins include polymers of one, two or more kinds of aliphatic hydrocarbons selected from olefins and dienes having about 4 to 5 carbon atoms, and the like. Examples of the olefin include 1-butene, isobutylene, 1-pentene, and the like. Examples of the diene include butadiene, 1,3-pentadiene, isoprene, and the like. Examples of an aromatic hydrocarbon resin include polymers of vinyl-group-containing aromatic hydrocarbons having 8 to 10 carbon atoms (styrene, vinyl toluene, α-methyl styrene, indene, methyl indene, etc.), and the like. Examples of a alicyclic hydrocarbon resins include products of polymerization of cyclic dimers of so-called “C4 petroleum fractions” and “C5 petroleum fractions”; polymers of cyclic diene compounds (cyclopentadiene, dicyclopentadiene, ethylidene norbornene, dipentene, etc.) or hydrogenation products of these polymers; alicyclic hydrocarbon-based resins obtainable by hydrogenation of aromatic rings in aromatic hydrocarbon resins or aliphatic-aromatic petroleum resins; and the like.

In the art disclosed herein, can be preferably used a tackifier resin having a softening point (softening temperature) of about 80° C. or above (preferably about 100° C. or above). According to such a tackifier resin, can be obtained a PSA sheet of higher performance (e.g., stronger adhesion). The upper limit of the softening point of the tackifier is not particularly limited. For instance, it can be about 200° C. or below (typically about 180° C. or below). The softening point of a tackifier resin as referred to herein is defined as a value measured in accordance with the softening point test method (ring and ball method) specified in either JIS K 5902 or JIS K 2207.

The amount of tackifier resin to be used is not particularly limited, and can be selected in accordance with the target adhesive properties (adhesive strength, etc.). For example, based on the solids content, relative to 100 parts by mass of the acrylic polymer, a tackifier resin is preferably used in an amount of about 10 to 100 parts by mass (more preferably 15 to 80 parts by mass, or even more preferably 20 to 60 parts by mass).

### <Substrate>

When the art disclosed herein is applied to a substrate-backed double-faced PSA sheet or a substrate-backed single-faced PSA sheet, a suitable substrate can be selected and used according to the intended purpose of the PSA sheet among plastic films such as polypropylene films, ethylene-propylene copolymer films, polyester films, polyvinyl chloride films, etc.; foam sheets made of foam such as polyurethane foam, polyethylene foam, polychloroprene foam, etc.; woven fabrics and non-woven fabrics (meaning to include paper such as Washi, high-grade paper, etc.) of a single species or a blend, etc., of various species of fibrous substances (which can be natural fibers such as hemp, cotton, etc.; synthetic fibers such as polyester, vinylon, etc.; semi-synthetic fibers such as acetate, etc.; inorganic fibers such as glass fibers, etc.; metal fibers; and the like); metal foil such as aluminum foil, copper foil, etc.; and the like. The plastic film (typically referring to a non-porous plastic film, which should be conceptually distinguished from a woven fabric and a non-woven fabric) may be a non-stretched film, or a stretched (uni-axially stretched or bi-axially stretched) film. The substrate surface to be provided with a PSA layer may have been subjected to a surface treatment such as primer coating, corona discharge treatment, or the like.

The substrate may contain various additives as necessary, such as fillers (inorganic fillers, organic fillers, etc.), anti-aging agents, antioxidant, UV-absorbing agents, antistatic agents, lubricants, plasticizers, colorants (pigments, dyes, etc.) and the like. The surface of the substrate may have been subjected to a known or commonly used surface treatment such as corona discharge treatment, plasma treatment, primer coating, or the like. Such a surface treatment can be, for instance, a treatment to increase the anchoring of the PSA layer by the substrate (i.e., a treatment to increase the non-releasability of the substrate surface). While the thickness of the substrate can be suitably selected depending on the purpose, in general, it is about 10 μm to 500 μm (preferably about 10 μm to 200 μm). The art disclosed herein can be practiced preferably in an embodiment of a PSA sheet having the solvent-based PSA layer on one or each face of such a substrate (which may be in an embodiment where a lower portion of the solvent-based PSA layer is integrated in the substrate).

The art disclosed herein can be practiced preferably in an embodiment of a substrate-backed double-faced PSA sheet having the solvent-based PSA layer on each of a first face and a second face of a porous substrate. In such an embodiment, a lower portion of the solvent-based PSA layer is typically integrated in the porous substrate (see FIG. 1). In order to increase the thickness of such a double-faced PSA sheet, the thickness of the PSA layer needs to be increased; and therefore, it is especially meaningful to apply the art disclosed herein and obtain a single, yet thick bubble-free PSA layer with low VOC.

As the porous substrate, can be preferably used non-woven fabrics known or commonly used in the field of double-faced PSA tape or other non-woven fabrics. The scope of the “non-woven fabric” herein include non-woven fabrics for PSA sheets used in the field of mainly PSA tapes and other PSA sheets, and the term typically refers to a non-woven fabric (which may be referred to as so-called “paper”) fabricated using a general paper making machine. For example, can be used non-woven fabrics constituted with natural fibers such as wood pulp, cotton, hemp (Manila hemp), etc.; non-woven fabrics constituted with chemical fibers (synthetic fibers) such as polyester fiber, rayon, vinylon, acetate fiber, polyvinyl alcohol (PVA) fiber, polyamide fiber, polyolefin fiber, polyurethane fiber, etc.; non-woven fabrics constituted with two or more fiber species that are different material-wise. Examples of porous substrates other than non-woven fabrics include various woven fabrics, metal meshes, and the like.

The thickness of the porous substrate is not particularly limited. It is usually preferable to use a porous substrate having a thickness of about 15 μm to 150 μm (typically about 30 μm to 120 μm, e.g., about 50 μm to 100 μm). The total thickness (the thickness of the substrate and the PSA layers combined excluding the thickness of any release liner) of a double-faced PSA sheet having the solvent-based PSA layer on each face of such a porous substrate can be, for instance, about 200 μm to 1 mm. For example, in a preferable embodiment of the art disclosed herein, the PSA sheet is a double-faced PSA sheet having the constitution described above and having a total thickness of about 200 μm to 600 μm (preferably 250 μm to 400 μm, e.g., 280 μm to 350 μm).

### <Method for Producing a PSA Sheet>

As a method for forming a PSA layer on a substrate, can be suitably employed (1) a method (direct method) where a PSA composition is directly provided (typically applied) to a non-releasable surface of a substrate and allowed to dry; (2) a method (transfer method) where a PSA composition is provided to a releasable surface of a substrate and allowed to dry to form a PSA layer on the surface followed by adhering and transferring the PSA layer to a non-releasable surface of a substrate; or any other method. For the releasable surface of a substrate, can be used, for instance, a surface of a release liner. Alternatively, with a substrate having a non-releasable first surface and a releasable second surface, the second surface can be used as the releasable surface. The transfer method is advantageous such that it is likely to produce a PSA sheet having a highly flat and smooth surface (adhesive face) to be adhered to an adherend. A PSA sheet having such a highly flat and smooth adhesive face may exhibit even better adhesive performance. Hence, by applying the art disclosed herein to form a solvent-based PSA layer having few bubbles and providing the PSA layer to a substrate by the transfer method, can be obtained a PSA sheet that exhibits yet greater adhesive performance.

When the double-faced PSA sheet has a PSA layer on each of a first face and a second face of a substrate, different methods can be employed between the first face and the second face. For example, a PSA layer may be provided on the first face by the transfer method while another PSA layer may be provided on the second by the direct method. From the standpoint of the adhesive performance, it is advantageous to provide at least one of the PSA layers by the transfer method. The art disclosed herein can be practiced preferably in an embodiment where the PSA sheet is a double-faced PSA sheet having a PSA layer provided by the transfer method on each of the first face and the second face of a substrate.

When applying the PSA composition, can be suitably employed various application methods conventionally known in the field of PSA sheets, such as roll coating, gravure roll coating, reverse roll coating, roll brushing, spray coating, air knife coating, die coating, and the like.

From the standpoint of the productivity, the PSA composition is preferably dried with heating. For instance, a PSA composition applied on a substrate can be placed in a drying oven, and after the PSA composition was dried with heating in the drying oven, it can be removed from the drying oven. Placement of the composition applied on the substrate in the drying oven and its removal therefrom can be carried out continuously (line production) or non-continuously (batch production). From the standpoint of the production efficiency of the PSA sheet, it is usually preferable to employ a line production system that carries out the placement and removal continuously. The set temperature of the drying oven can be suitably selected in view of the solvent composition, NV, viscosity and coating thickness of the solvent-based PSA composition, the type of the substrate, the time spent in the drying oven (the line speed in a line production system), and so on. In a drying oven having some zones, in view of the respective conditions listed above, the set temperature of each zone can be suitably selected.

The PSA sheet disclosed herein can be preferably produced by allowing the solvent-based PSA composition applied on a substrate to dry under the following conditions while the solvent-based PSA layer is being formed: In particular, when T_{Omax} is the maximum set temperature of the drying oven and T_{Amax} is the maximum temperature reached at the surface of the solvent-based PSA composition in the drying oven, T_{Omax}-T_{Amax} may be 20° C. or below (typically 0° C. to 20° C.). As such, with T_{Omax}-T_{Amax} (or “ΔT” hereinafter) being a prescribed value or smaller, can be formed a PSA layer having a lower residual solvent content and having fewer bubbles when compared to a PSA layer dried under a condition with a larger ΔT. With ΔT being 15° C. or smaller, can be obtained even better results. It is usually suitable that ΔT is 1° C. or larger (preferably 3° C. or larger, e.g., 5° C. or larger) from the standpoint of preventing degradation of the PSA due to excessive drying, preventing excessive cross-linking at and near the PSA layer surface during the drying process (such an event may become a cause to lower the degree of integration of the PSA layer in the non-woven fabric substrate when the PSA sheet is fabricated by transferring the PSA layer to a non-woven fabric substrate), preventing an excessive decrease in the productivity, and other like events. ΔT is preferably 5° C. or larger (e.g., 6° C. or larger) also from the standpoint of allowing easy temperature management using a temperature gauge sticker.

In a preferable embodiment, the PSA sheet disclosed herein exhibits a 180° peel strength (more specifically referring to an adhesive strength measured by the adhesive strength measurement described later in the worked examples) of 10 N/20 mm or greater, or more preferably 12 N/20 mm or greater when measured with respect to the adhesive face of the solvent-based PSA layer. A preferable PSA sheet results in a peeled length of smaller than 10 mm (more preferably smaller than 5 mm) when tested on its peel property under a constant load (peel property under a constant load evaluated according to the method described later in the worked example) with respect to the adhesive face of the solvent-based PSA layer.

The subject matter disclosed in the present description includes the following:

(1) A PSA sheet comprising a single PSA layer having a thickness of 100 μm or larger (typically larger than 100 μm, but 300 μm or smaller), wherein

the PSA layer is formed from a solvent-based PSA composition and satisfies the following conditions:

when a cross-sectional area vertical to the PSA layer is observed, the PSA layer has fewer than 1.0 bubble of 100 μm size or larger per mm² of cross-sectional area; and

when the PSA layer is stored at 80° C. for 30 minutes, the mass of toluene released from the PSA layer is 10000 ppm or less of the mass of the PSA layer.

(2) The PSA sheet according to (1) above, wherein the PSA layer has a thickness of 120 μm to 200 μm (e.g., 130 μm to 180 μm).
(3) The PSA sheet according to (1) or (2) above, wherein the PSA composition comprises an acrylic polymer as a based polymer.
(4) The PSA sheet according to any one of (1) to (3) above, wherein the PSA composition comprises an organic solvent, with greater than 50% by mass (typically 55% by mass or greater, e.g., 60% by mass or greater) of the organic solvent being toluene.
(5) The PSA sheet according to any one of (1) to (4) above, wherein the PSA composition has a 30 to 50% (e.g., 35 to 45%) NV by mass.
(6) The PSA sheet according to any one of (1) to (5) above, with the PSA sheet being constituted as a double-faced PSA sheet comprising the PSA layer on each of a first face and a second face of a non-releasable substrate.
(7) The PSA sheet according to (6) above, wherein the non-releasable substrate is a porous body (e.g., a non-woven fabric).
(8) A method for producing a PSA sheet comprising:

a step (application step) of applying a solvent-based PSA composition to a substrate, and

a step (drying step) of allowing the PSA composition to dry on the substrate to obtain the PSA layer, with the drying step comprising placing the PSA composition applied on the substrate in a drying oven and removing it from the drying oven, and the drying step being carried out while satisfying the following condition:

when T_{Omax} is the maximum set temperature of the drying oven and T_{Amax} is the maximum temperature reached at a surface of the solvent-based PSA composition in the drying oven, T_{Omax}-T_{Amax} (ΔT) is 20° C. or below (typically 0° C. to 20° C., preferably 5° C. to 20° C., e.g., 5° C. to 15° C.).

In (8) above, in the application step, the solvent-based PSA composition is preferably applied to the substrate so as to form a PSA layer having a thickness of 100 μm or larger after dried. The production method can be applied preferably for production of the PSA sheet according to any one of (1) to (7) above.

(9) The method according to (8) above, wherein a releasable substrate is used as the substrate, the method further comprising:
a step (transfer step) of adhering the PSA layer on the substrate to a non-releasable substrate after the drying step.
(10) The method according to (8) or (9) above, further comprising:
(a) T_{Amax} is determined by placing a temperature gauge sticker on top of the PSA composition applied on the substrate and carrying out the drying step under a prescribed drying condition,
(b) ΔT is computed with respect to the T_{Amax} value determined,
(c) whether or not the ΔT value is within a range of 0° C. to 20° C. (preferably 5° C. to 20° C., e.g., 5° C. to 15° C.) is determined, and
(d1) when the ΔT value is within the range indicated above, the PSA sheet is produced by continuously applying the drying condition, or
(d2) when the ΔT value is out of the range indicated above, the (a) to (c) are carried out again after modifying the drying condition.
(11) The method according to any one of (8) to (10) above, wherein placement of the PSA composition applied on the substrate in the drying oven and its removal from the drying oven are carried out by allowing the PSA composition on the substrate to continuously pass through the drying oven.

### EXAMPLES

Several experimental examples relating to the present invention are described below, although these specific examples are not intended to limit the scope of the invention. In the description that follows, unless noted otherwise, all references to “parts” and “%” are based on mass. The respective properties described below were measured or evaluated as follows.

### 1. Evaluation of the Number of Bubbles

Samples for observation were obtained from a right portion, a central portion and a left portion of each double-faced PSA sheet (with a 100 mm wide PSA layer). In particular, the double-faced PSA sheet was cut along the length direction at 5 mm, 35 mm, 65 mm and 95 mm lines from one edge of the width direction to obtain three 30 mm wide samples corresponding to the right portion, central portion and left portion. These samples for observation were subjected to a heavy metal-staining treatment (a treatment where 4% osmic acid solution is used to steam-stain an object at 50° C. for 4 hours), and then cut using a freezing microtome. The cut was made along the width direction of each sample for observation and vertical to the PSA layer (i.e., in the depth direction of the PSA layer). This was fixed on a stage with a conductive PSA tape and subjected to a Pt—Pd spattering treatment for 15 seconds. The resultant was observed with an SEM (field emission scanning electron microscope “S-4800” available from Hitachi Corporation was used). Observation was made over a 1 mm range at the center of each sample. With respect to this range, the cross-sectional area of the sample was observed all across the thickness and the size of each bubble appeared in the cross-sectional area was measured. The bubble size was determined by measuring the distance across two points using an image-analysis software. With the respective samples corresponding to the right portion, central portion and left portion, the results of the bubble size measurements were gathered and the number of bubbles (the total number of bubbles for the three observation regions) of 100 μm or larger was determined. The number of bubbles was converted to the number of bubbles per mm² of cross-sectional area of the double-faced PSA sheet. The size measurement was made only for the bubbles whose circumferences were fully contained in the observation range (1 mm wide range).

### 2. Measurement of the Thickness of PSA Layers

Similarly to the evaluation of the number of bubbles, SEM observations were made over center regions of the width direction of the respective samples corresponding to the right portion, the central portion and the left portion of each double-faced PSA sheet. Based on the observations, the thickness of each PSA layer provided on each face of the non-woven fabric and the overall thickness of the sample were determined as average values among the three samples (the right, central and left portions).

The distance from the surface of each PSA layer through the lower end of the depth to which the PSA layer was integrated in the non-woven fabric was recorded as the thicknesses for the two PSA layers in each double-faced PSA sheet. When no clear interface was present between the two PSA layers, the distance from the surface of each PSA layer through the halfway point of the thickness of the non-woven fabric was recorded as the thickness of each PSA layer.

### 3. Measurement of the Amount of Toluene Released

Each double-faced PSA sheet was cut to a prescribed size (surface area: 5 cm²) to prepare a sample. From one adhesive face of the sample, the release liner was removed, and the adhesive face was adhered to an aluminum sheet. The release liner covering the other adhesive face was removed to expose the adhesive face, the sample was placed in a vial of volume 20 mL, and the vial was closed and sealed. Subsequently, the vial containing the sample was heated at 80° C. for 30 minutes, and a 1.0 mL sample of the air inside the vial was injected while hot into a GC analyzer via a head space autosampler. The value measured was converted to the toluene content (the amount of toluene released) (ppm) per mass of the PSA contained in the sample (double-faced PSA sheet).

Conditions for the GC analysis were as follows:
Column: DB-FFAP 1.0 μm (0.535 mm diameter, 30 m long)
Carrier gas: He 5.0 mL/min
Column head pressure: 23 kPa (40° C.)
Injector: split (split ratio 12:1, temperature 250° C.)
Column temperature: 40° C. (0 min)-<+10° C./min>-250° C. (9 min) [indicating that the temperature was raised from 40° C. at a rate of 10° C./min to 250° C. and maintained at 250° C. for 9 minutes]
Detector: FID (temperature 250° C.)

### 4. Measurement of Adhesive Strength

The release liner covering one adhesive face of each double-faced PSA sheet was removed, and the exposed adhesive face was adhered to a 25 μm thick polyethylene terephthalate (PET) film for backing. This backed PSA sheet was cut into a size of 20 mm wide by 100 mm long to prepare a test piece. In an environment at 23° C. and 50% RH, the release liner covering the other adhesive face of the test piece was removed, and the test piece was pressure-bonded to an adherend surface with a 2 kg roller moved back and forth once. After this was left in the same environment for 30 minutes, based on JIS Z0237, using a tensile tester, the 180° peel strength (N/20 mm-width) was measured at a tensile speed of 300 mm/min. A stainless steel (SUS304) plate was used as the adherend, and the adhesive strength was measured following the procedure described above.

### 5. Peel Property Under a Constant Load

First adhesive face 5A of double-faced PSA sheet 5 was adhered to PET film 52 of 25 μm thickness for backing (see FIG. 5). The backed PSA sheet 5 was cut into a piece of 10 mm wide by 100 mm long to prepare specimen 54. In an environment at 23° C. and 50% RH, second adhesive face 5B of specimen 54 was adhered to the surface of adherend 56 by moving a 2 kg roller back and forth once. This was left in the same environment for 30 minutes. Subsequently, in an environment at 23° C. and 50% RH, as shown in FIG. 5, adherend 56 was horizontally held so that the surface having specimen 54 faced down. Load 58 of 300 g (2.9N) was placed on one end of specimen 54 so as to have a peel angle of 90°, and after a lapse of 24 hours, the peeled length was measured. Using a stainless steel (SUS304) plate as the adherend, the peel property (peeled length) under a constant load in a normal condition was evaluated.

### Example 1

### Preparation of PSA Composition

To a three-neck flask, were placed 3 parts of acrylic acid, 4 parts of vinyl acetate, 93 parts of n-butyl acrylate, 0.1 part of hydroxyethyl acrylate, and 200 parts of toluene as a polymerization solvent. The resulting mixture was stirred under a nitrogen flow for 2 hours to remove oxygen from the polymerization system. Subsequently, 0.15 part of 2,2′-azobisisobutyronitrile (AIBN) was added. The resulting reaction mixture was heated to 70° C. and stirred for 6 hours to effect the polymerization reaction. A polymer solution (a toluene solution of an acrylic polymer) was thus obtained. The resulting polymer had a weight average molecular weight of 70×10⁴.

To the polymer solution, relative to 100 parts of its solid content, were added 40 parts of a tackifier resin (a polymerized rosin ester, trade name “PENSEL D125” available from Arakawa Chemical Co., Ltd.) and 1.4 part of an isocyanate-based crosslinking agent (trade name “CORONATE L” available from Nippon Polyurethane Kogyo Co., Ltd.) and toluene in an amount enough to obtain 40% final solid content. The resultant was sufficiently stirred to prepare an acrylic PSA composition A1. This acrylic PSA composition had a viscosity of 10 Pa·s at 23° C. The viscosity was measured by the method described below.

### [Viscosity Measurement Method]

The temperature of each PSA composition was adjusted to 23° C. Using a type BH rotational viscometer available from Tokimec Inc., the viscosity of the PSA composition was measured at a rotational speed of 20 rpm.

### [Fabrication of Double-Faced PSA Sheets]

The PSA composition A1 was applied to a release liner (substrate) having a release layer treated with a silicone-based release agent. For the release liner, was used trade name “75 EPS (M) Cream (kai)” available from Oji Specialty Paper Co., Ltd. The coating amount of the PSA composition A1 was adjusted to yield a thickness of 150 μM after dried. A temperature gauge sticker was placed on top of the coating and the resultant was passed continuously through a drying oven at a maximum set temperature T_{Omax} of 100° C. As the temperature gauge sticker, was used trade name “HEAT-LABEL”, type “CR—C”, available from Micron Corporation. The line speed was adjusted so that the PSA composition A1 was allowed to stay in the drying oven for 180 seconds. A 150 μm thick solvent-based PSA layer was thus formed on the release liner.

The release liner-backed solvent-based PSA layer was cut to obtain two sheets having a suitable length. The PSA layers were adhered to the respective faces of a porous substrate and pressed to fabricate (by the transfer method) a double-faced PSA sheet according to Example 1. For the porous substrate, was used a non-woven fabric constituted with 100% Manila hemp fiber and having a thickness of 75 μm and a grammage of 23 g/cm². The length direction of the double-faced PSA sheet coincided with the coating direction of the PSA composition and the machine direction of the non-woven fabric. The double-faced PSA sheet had a total thickness of about 300 μm. Each adhesive face of the double-faced PSA sheet was kept protected with the corresponding release liner used for the fabrication of the double-faced PSA sheet.

When the temperature gauge sticker passed through the drying oven was inspected, the 88° C. window had changed color while the 93° C. window had remained unchanged (the maximum temperature reached T_{Amax}=(88+93)/2=90.5° C.). Thus, ΔT in the present example was 9.5° C.

### Example 2

In the present example, the line speed was adjusted so that the PSA composition A1 was allowed to stay in the drying oven for 90 seconds. As the temperature gauge sticker, was used trade name “HEAT-LABEL”, type “CR-B”, available from Micron Corporation. Otherwise in the same manner as Example 1, a 150 μm thick solvent-based PSA layer was formed on the release liner. When the temperature gauge sticker passed through the drying oven was inspected, the 71° C. window had changed color while the 77° C. window had remained unchanged (the maximum temperature reached T_{Amax}=(71+77)/2=74° C.). Thus, ΔT in the present example was 26° C. Using this release liner-backed solvent-based PSA layer, in the same manner as Example 1, was fabricated a double-faced PSA sheet (about 300 μm total thickness).

### Example 3

In the present example, the coating amount of the PSA composition A1 was adjusted to yield a thickness of 70 μm after dried. As the temperature gauge sticker, was used trade name “HEAT-LABEL”, type “CR-B”, available from Micron Corporation. The line speed was adjusted so that the maximum temperature reached T_{Amax} of the temperature gauge sticker was similar to that of Example 2 (in other words, in the temperature gauge sticker passed through the drying oven, the 71° C. window would change color while the 93° C. window would remain unchanged). Using this release liner-backed solvent-based PSA layer, in the same manner as Example 1, was fabricated a double-faced PSA sheet (about 140 μm total thickness).

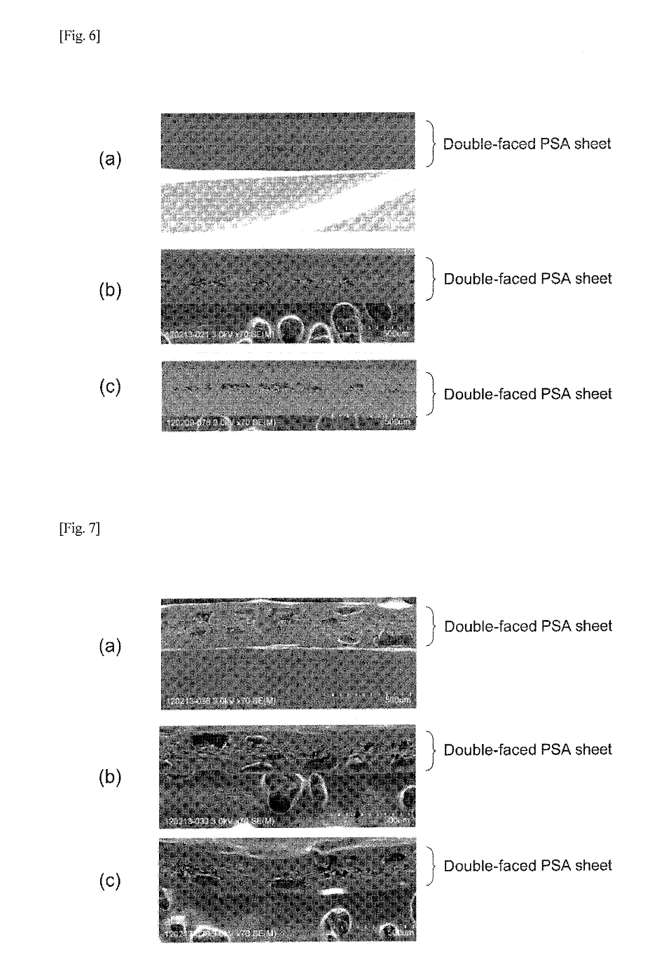

The double-faced PSA sheet obtained in each example was subjected to measurements and evaluation of the thickness of PSA layers, the total thickness of the double-faced PSA sheet, the number of bubbles, the amount of toluene released, the adhesive strength and the peel property under a constant load in the above-mentioned manners. The results are shown in Table 1 along with the thickness of the non-woven fabrics used and the values of ΔT. For all double-faced PSA sheets of Examples 1 to 3, the thickness of the PSA layer was almost the same between the two faces. Thus, Table 1 shows the average value between the two faces. FIG. 6 shows SEM images used for the evaluation of the number of bubbles for the double-faced PSA sheet of Example 1 and the measurement of the thickness of PSA layers. FIG. 7 shows SEM images used for the evaluation of the number of bubbles for the double-faced PSA sheet of Example 2 and the measurement of the thickness of PSA layers. Among these images, (a), (b) and (c) are SEM images of the samples collected from the right portion, central portion, and left portion of the double-faced PSA sheet, respectively.

TABLE 1

| | Example | | | | | |
|---|---|---|---|---|---|---|
| | 1 | | 2 | | 3 | |
| Thickness of PSA layer | 150 | μm | 150 | μm | 70 | μm |
| (per face) | | | | | | |
| Thickness of non-woven | 75 | μm | 75 | μm | 75 | μm |
| fabric | | | | | | |
| Overall thickness of | 300 | μm | 300 | μm | 140 | μm |
| double-faced PSA | | | | | | |
| sheet | | | | | | |
| ΔT | 9.5° | C. | 26° | C. | 26° | C. |
| Number of bubbles (per | 0 | | 16 | | 0 | |
| mm² of cross- | | | | | | |
| sectional area) | | | | | | |
| Amount of toluene released | 5,000 | ppm | 15,000 | ppm | 3,000 | ppm |
| Adhesive strength | 15N/20 mm | | 8N/20 mm | | 11N/20 mm | |
| Peel under a constant load | 1 | mm | 20 | mm | 5 | mm |

As shown in Table 1, between the double-faced PSA sheets of Examples 1 and 2, with each comprising a single solvent-based PSA layer having a thickness of 100 μm or larger on each face of a non-woven fabric substrate, the double-faced PSA sheet of Example 1 in which the solvent-based PSA composition had been formed under a drying condition set so as to give ΔT of 20° C. or smaller (more specifically 5° C. to 15° C., here 5° C. to 10° C.) had fewer than 1.0 bubble per mm² (in particular, 0 bubble per mm²) in the PSA layer, with the PSA layer being highly flat and smooth. This indicates that a high adhesive strength and excellent peel property under a constant load were obtained. It was also confirmed that with respect to the double-faced PSA sheet according to Example 1, the number of bubbles and the amount of toluene released were reduced both to large extents at the same time.

On the contrary, the double-faced PSA sheet of Example 2 comprising a solvent-based PSA layer dried under a condition with ΔT being larger than 20° C. (more specifically, under a condition with ΔT being 25° C. or larger) had 16 bubbles per mm² in the PSA layer, with the PSA layer being clearly inferior to that of Example 1 in terms of the flatness and smoothness of the adhesive surfaces. It is presumed that such a difference in the flatness and smoothness were reflected in the adhesive strength and peel property under a constant load. The amount of toluene released from the PSA layer was clearly higher (by approximately 3-fold) with the double-faced PSA sheet of Example 2 than with that of Example 1.

With respect the double-faced PSA sheet of Example 3 comprising solely single solvent-based PSA layers each having a thickness smaller than 100 μm (in particular, single PSA layers each having a thickness of 70 μm), while the ΔT value was similar to that of Example 2, it did not suffer from the bubble formation issue while the amount of toluene released was at a similar level or lower as that of Example 1. In other words, the double-faced PSA sheet to which the art disclosed herein had been applied comprised a single PSA layer having a thickness of 100 μm or larger, with the PSA layer exhibiting a bubble formation-preventing capability (and further, degrees of flatness and smoothness on the surface) comparable to that of a solvent-based PSA layer having a conventional thickness of about 70 μm or a smaller thickness while yielding a reduced amount of toluene released.

What is claimed is:

1. A pressure-sensitive adhesive sheet comprising a single pressure-sensitive adhesive layer having a thickness of 100 μm or larger, wherein
the pressure-sensitive adhesive layer is formed from a solvent-based pressure-sensitive adhesive composition and satisfies the following conditions:
when a cross-sectional area vertical to the pressure-sensitive adhesive layer is observed, the pressure-sensitive adhesive layer has fewer than 1.0 bubble of 100 μm size or larger per mm² of cross-sectional area; and
when the pressure-sensitive adhesive layer is stored at 80° C. for 30 minutes, the mass of toluene released from the pressure-sensitive adhesive layer is 10000 ppm or less of the mass of the pressure-sensitive adhesive layer.

2. The pressure-sensitive adhesive sheet according to claim 1, wherein the pressure-sensitive adhesive layer has a thickness of 120 μm to 200 μm.

3. The pressure-sensitive adhesive sheet according to claim 1, wherein the pressure-sensitive adhesive composition comprises an acrylic polymer as a based polymer.

4. The pressure-sensitive adhesive sheet according to claim 1, wherein the pressure-sensitive adhesive composition comprises an organic solvent, and the organic solvent comprises toluene in an amount greater than 50% by mass of the organic solvent.

5. The pressure-sensitive adhesive sheet according to claim 1, wherein the pressure-sensitive adhesive composition has a 30% to 50% solid content by mass.

6. The pressure-sensitive adhesive sheet according to claim 1, wherein the pressure-sensitive adhesive sheet is constituted as a double-faced pressure-sensitive adhesive sheet comprising the pressure-sensitive adhesive layer on each of a first face and a second face of a non-releasable substrate.

7. The pressure-sensitive adhesive sheet according to claim 6, wherein the non-releasable substrate is a porous body.

8. A method for producing a pressure-sensitive adhesive sheet comprising:
a step (application step) of applying a solvent-based pressure-sensitive adhesive composition to a substrate; and
a step (drying step) of allowing the pressure-sensitive adhesive composition to dry on the substrate to obtain the pressure-sensitive adhesive layer,
wherein the drying step comprises: placing the pressure-sensitive adhesive composition applied on the substrate in a drying oven; and removing it from the drying oven, and
the drying step is carried out while satisfies the following condition:
when T_{Omax} is the maximum set temperature of the drying oven and T_{Amax} is the maximum temperature reached at a surface of the solvent-based pressure-sensitive adhesive composition in the drying oven, T_{Omax}-T_{Amax} (ΔT) is 20° C. or below.

9. The method according to claim 8, wherein a releasable substrate is used as the substrate, the method further comprising a step (transfer step) of adhering the pressure-sensitive adhesive layer on the substrate to a non-releasable substrate after the drying step.

10. The method according to claim 8, wherein:
(a) T_{Amax} is determined by placing a temperature gauge sticker on top of the pressure-sensitive adhesive composition applied on the substrate and carrying out the drying step under a prescribed drying condition,
(b) ΔT is computed with respect to the T_{Amax} value determined,
(c) whether or not the ΔT value is within a range of 0° C. to 20° C. is determined, and
(d1) when the ΔT value is within the range indicated above, the pressure-sensitive adhesive sheet is produced by continuously applying the drying condition, or
(d2) when the ΔT value is out of the range indicated above, the (a) to (c) are carried out again after modifying the drying condition.

11. The method according to claim 8, wherein placement of the pressure-sensitive adhesive composition applied on the substrate in the drying oven and its removal from the drying oven are carried out by allowing the pressure-sensitive adhesive composition on the substrate to continuously pass through the drying oven.

12. The pressure-sensitive adhesive sheet according to claim 2, wherein the pressure-sensitive adhesive composition comprises an acrylic polymer as a based polymer.

13. The pressure-sensitive adhesive sheet according to claim 2, wherein the pressure-sensitive adhesive composition comprises an organic solvent, and the organic solvent comprises toluene in an amount greater than 50% by mass of the organic solvent.

14. The pressure-sensitive adhesive sheet according to claim 2, wherein the pressure-sensitive adhesive composition has a 30% to 50% solid content by mass.

15. The pressure-sensitive adhesive sheet according to claim 2, wherein the pressure-sensitive adhesive sheet is constituted as a double-faced pressure-sensitive adhesive sheet comprising the pressure-sensitive adhesive layer on each of a first face and a second face of a non-releasable substrate.

16. The pressure-sensitive adhesive sheet according to claim 15, wherein the non-releasable substrate is a porous body.

17. The method according to claim 9, wherein:
(a) T_{Amax} is determined by placing a temperature gauge sticker on top of the pressure-sensitive adhesive composition applied on the substrate and carrying out the drying step under a prescribed drying condition,
(b) ΔT is computed with respect to the T_{Amax} value determined,
(c) whether or not the ΔT value is within a range of 0° C. to 20° C. is determined, and
(d1) when the ΔT value is within the range indicated above, the pressure-sensitive adhesive sheet is produced by continuously applying the drying condition, or
(d2) when the ΔT value is out of the range indicated above, the (a) to (c) are carried out again after modifying the drying condition.

18. The method according to claim 9, wherein placement of the pressure-sensitive adhesive composition applied on the substrate in the drying oven and its removal from the drying oven are carried out by allowing the pressure-sensitive adhesive composition on the substrate to continuously pass through the drying oven.

19. The pressure-sensitive adhesive sheet according to claim 3, wherein the pressure-sensitive adhesive composition comprises an organic solvent, and the organic solvent comprises toluene in an amount greater than 50% by mass of the organic solvent.

20. The pressure-sensitive adhesive sheet according to claim 3, wherein the pressure-sensitive adhesive composition has a 30% to 50% solid content by mass.
